(19) United States
(12) Patent Application Publication
(10) Pub. No.: US 2002/0009119 A1
(43) Pub. Date: Jan. 24, 2002

(54) Environmental heat stress monitor

(76) Inventors: William T. Matthew, Hopkinton, MA (US); Leander A. Stroschein, Natick, MA (US); Joseph M. McGrath, Holliston, MA (US)

Correspondence Address: Office of the Staff Judge Advocate, U.S. Army Medical Research and Material Command, ATTN: MCMR-JA (Ms. Elizabeth Arwine), 504 Scott Street, Fort Detrick, MD, 21702-5012, US

(21) Appl. No.: 09/780,571

(22) Filed: Feb. 12, 2001

Related U.S. Application Data
(60) Provisional application No. 60/182,051, filed on Feb. 11, 2000.

(51) Int. Cl. G01K 13/00; G01N 25/00

(52) U.S. Cl. 374/45; 374/142; 374/143

(57) ABSTRACT

A portable stress monitor is provided for monitoring conditions under which physiological activity is occurring. The conditions monitored may be environmental, such as ambient temperature and humidity, or physiological, such as heart rate or body temperature. The monitor includes a main body portion and a hinged cover. The hinged cover includes a removable sensor module. One or more sensors are attached to the sensor module, each sensor may be pivotally mounted on a mast, such that the sensors extend outwardly from the hinged cover when the sensor module is in the deployed position and may be pivoted to sit substantially flush with the hinged cover when the sensor module is in the storage position. A central processing unit is contained within the main body, and is operable to process data acquired by the sensors according to a heat strain algorithm. A display is attached to the outer surface of the main body for providing read out information, and an input device is provided for user input.

### CROSS-REFERENCE TO RELATED APPLICATIONS

This application claims priority from provisional application Ser. No. 60/182,051 filed Feb. 11, 2000.

### STATEMENT REGARDING FEDERALLY SPONSORED RESEARCH

Not Applicable.

### BACKGROUND OF THE INVENTION

1. Field of the Invention

The invention relates generally to the filed of environmental data acquisition systems, and particularly to portable environmental heat stress monitors that can be used to monitor the effects of exposure to extreme environmental conditions.

2. Description of Related Art

Military leaders, industrial managers and athletic trainers are all confronted with the problem of achieving high productivity or performance and safeguarding health under conditions of high heat or heat stress. Heat stress is the aggregate of all environmental and physical work factors that impose a heat load on the body. The environmental factors of heat stress include the air temperature, radiant heat, air movement, relative humidity and barometric pressure. Physical work contributes to the aggregate by producing metabolic heat in the body in direct proportion to the intensity of activity. The amount and type of clothing also can affect the heat load.

Several methods have been developed to index the conditions that lead to heat stress. Of these, the Web Bulb Globe Temperature (WBGT) is a popular measure in use in military, government and industrial arenas. The WBGT index is relatively simple to compute. It is defined by:

WBGT=0.7(WB)+0.2(GT)+0.1(DB)

where:

WB=natural wet-bulb temperature

GT=6-inch diameter black Vernon-globe temperature (indicating radiant heat)

DB=shaded dry-bulb temperature

For indoor use involving radiant heat sources other than direct solar radiation, the equation modifies to:

WBGT_{indoors}=0.7(WB)+0.3(GT)

Guidelines for determining work/rest schedules or protective measures for persons exposed to heat stress conditions, based on the WBGT index have been used in government and industry. However, the major use of WBGT measurements is in evaluation and quantification of the environment in industries such as aluminum production, steel production, foundry work, and the chemical and refinery fields where workers are routinely exposed to high radiant and convective heat. With accurate index to heat-stress levels, worker comfort and health can be assured while maintaining peak productivity and efficiency.

While the WBGT has proved to be a workable index, there are several factors that contribute to heat stress that are not accounted for by the WBGT index. Therefore, there is a need for a more comprehensive measure for heat stress.

Heat stress often affects workers in isolated locations, e.g., the battlefield, oil rigs, in mine shafts, in quarries etc. Accordingly, it is desirable to have a portable measurement device so that measurements can easily be taken in locations that are not readily accessible. Previous monitoring devices have sensors that are mounted to a tripod and attached to a separate display units by cables. This can limit their use to areas that can physically accommodate such equipment. Other devices use individual sensors that directly attach to the display unit, and are removed and placed in a protective case for storage. There is a need for a portable, self contained device that may be carried and operated by a worker without additional accessories.

### SUMMARY OF THE INVENTION

One embodiment of the invention may be realized by a portable stress monitor for monitoring conditions under which physiological activity is occurring. The conditions monitored may be environmental, such as ambient temperature and humidity, or physiological, such as heart rate or body temperature. The monitor includes a main body portion and a hinged cover. The hinged cover includes a removable sensor module. One or more sensors are attached to the sensor module, each sensor may be pivotally mounted on a mast, such that the sensors extend outwardly from the hinged cover when the sensor module is in the deployed position and may be pivoted to sit substantially flush with the hinged cover when the sensor module is in the storage position. A central processing unit is contained within the main body, and is operable to process data acquired by the sensors according to a heat strain algorithm. A sensor electronics circuit is contained within the sensor module, and is operable to perform sensor-related functions, such as signal conditioning and A/D conversion. A display is attached to the outer surface of the main body for providing read out information, and a keypad is provided for user input.

An advantage of the heat/stress monitor according to the present invention is that tailored heat stress management guidance is provided based on clothing worn, acclimatization status and work level.

Another advantage of the heat stress monitor according to the present invention is that the sensor suite and the central processor permit flexible implementation of additional physiological models or supplemental environmental stress parameters. More particularly, this invention permits facile adjustment of the heat strain algorithm.

Still a further advantage of the invention is the removable sensor module allows rapid replacement of the sensors as a single unit for repair and calibration.

### BRIEF DESCRIPTION OF THE FIGURES.

FIG. 1 is a block diagram of the heat stress monitor in accordance with the present invention.

FIG. 2 is a computational diagram of a preferred heat strain algorithm in accordance with the present invention.

FIG. 3 is a side view of an embodiment of the heat stress monitor of the invention illustrating the sensors in a deployed position.

FIG. 4 is a top view of the embodiment shown in FIG. 3 depicting the sensors in a storage position.

FIG. 5 is a side cut away view of the embodiment shown in FIG. 3 illustrating the sensors in a storage position and illustrating the system for coupling the sensors to the body.

FIG. 6 is an exploded view of a sensor coupling system in accordance with the invention showing the mast and the cuff.

FIG. 7 is an exploded view of the sensor coupling system of FIG. 6 illustrating only the cuff.

FIG. 8 depicts the wind speed sensor and the dry bulb sensor in a storage position.

FIG. 9 is a perspective front view of the stress monitor, with the sensor module in the “deployed” position.

FIG. 10 is a perspective rear view of the stress monitor of FIG. 9.

FIG. 11 is a perspective view of the sensor module of FIGS. 9 and 10.

FIG. 12 is a perspective front view of the assembled main body of FIGS. 9 and 10.

FIG. 13 is a block diagram of the main electronics contained within the main body.

FIG. 14 is a block diagram of the sensor electronics contained within the sensor module.

### DETAILED DESCRIPTION OF THE INVENTION

The apparatus, systems and methods of the present invention may be used for monitoring environmental conditions. A better understanding of the several embodiments of the invention and their use for monitoring environmental conditions will be achieved by reading the following description in conjunction with the above-incorporated references.

The present invention encompasses a compact, self-contained monitor that measures environmental conditions and calculates related safety factors and environmental stress parameters. The monitor preferably includes a main body and a sensor module. The sensor module preferably includes a number of environmental sensors including an atmospheric pressure sensor, a humidity sensor, an air temperature sensor, a wind speed sensor, and a solar radiation sensor. The sensor module is preferably releasably engaged with the main body such that the sensor module may be movable between a deployed position and a storage position and such that the sensor module may be readily replaced according to the intended use of the environmental monitor.

The sensor module may be provided with circuitry required to operate the various sensors. For example, the sensor module may be provided with A/D and D/A converters for processing current and voltage generated and/or required by the sensors and a memory device that stores calibration information for the sensors.

The main body may include a main processor for operating the monitor, a display for exhibiting input parameters, a central processing unit for computing safety factors and environmental stress parameters using manually input as well as measured environmental parameters. In some embodiments, the main body may include a communication port for facilitating communication with a local or remote server.

In other embodiments the central processing unit may be separate and distinct from the maim body and, for example, disposed in a server that communicates with the main body.

In accordance with preferred aspect of the invention, the central processing unit may be programmed according to a heat strain prediction model to calculate selected environmental safety factors e.g., work/rest cycle limits, hourly drinking water requirements and maximum safe work times. These selected environmental safety factors may be calculated based upon inputs from the environmental sensors as well as manual inputs from a user and/or remote inputs from a server, e.g., type of clothing worn by subject, work rate, and acclimatization status.

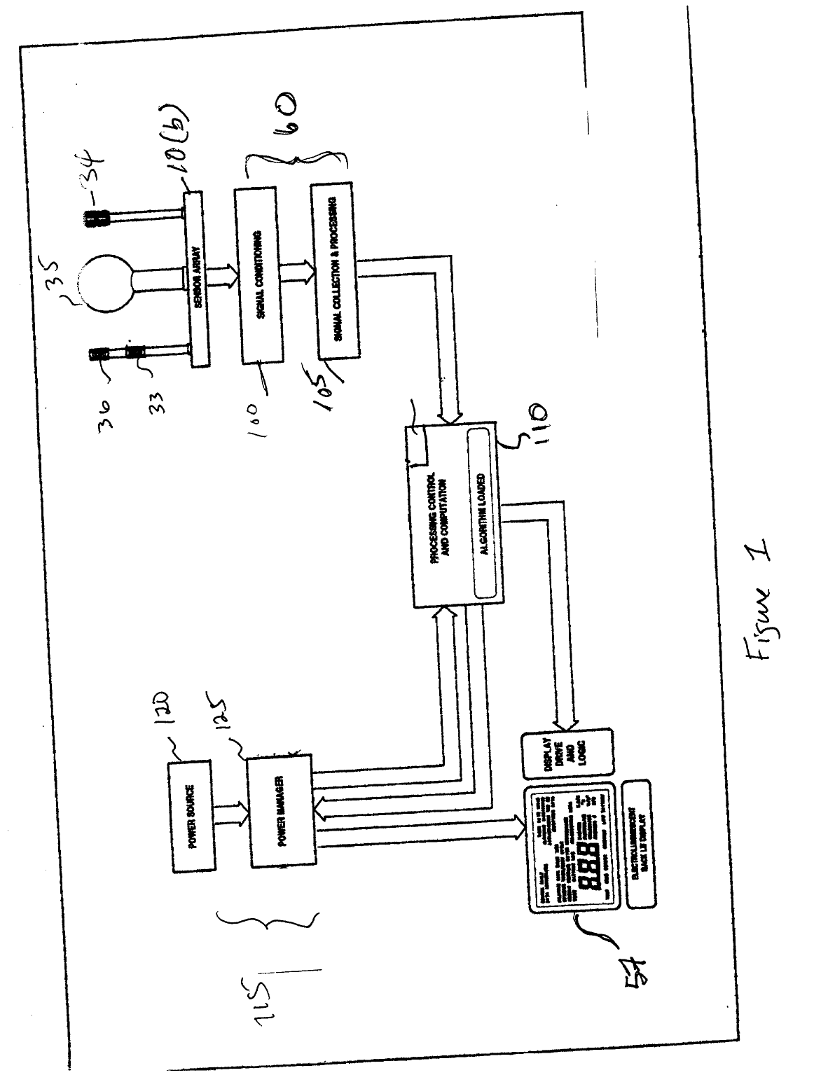

FIG. 1 illustrates an environmental data monitor in accordance with a preferred embodiment of the invention. A sensor module 10b is provided with a plurality of sensors including a dry bulb sensor 33, a relative humidity sensor 34, a globe sensor 35 and a wind speed sensor 36. In addition, sensor module 10b also includes an atmospheric pressure sensor 37 not illustrated in FIG. 1. Sensors 33-37 each collect data to be transmitted to a central processing unit 110. Each of the sensors 33-37 and central processing unit 110 are described in greater detail below in connection with specific embodiments of the invention. Sensor module 10b further includes sensor electronics 60 which may comprise signal conditioning circuitry 100 and collection and processing circuitry 105. Signal conditioning circuitry 100 preferably converts signals transmitted and received by the sensors to a form usable by other system circuitry. Collection and processing circuitry 105 includes a suitable memory device that stores information unique to sensors 33-37. For example, collection and processing circuitry 105 may store calibration information related to sensors 33-37 and facilitate recalibration. While it is preferable that sensor electronics 60 be included in sensor module 10b, in other embodiments, sensor electronics may be disposed in main body 10a.

In some embodiments, a graphical display 57 may be disposed in main body 10a. Display 57 is preferably provided with a menu that allows a user to select parameters to be input to central processing unit 110. In accordance with the invention, the menu allows the user to select parameters related to environmental stress for input to central processing unit 110. Display 57 is preferably a backlit LCD display of the type generally known to those of skill in the art.

In other embodiments, no display is provided with main body 10a. In these embodiments, a user may input environmental stress parameters at a remote location and those parameters may be transmitted to environmental monitor 10 by any method of signal transmission. For example, the signals may be transferred wirelessly, via the Internet, through a direct modem connection, via satellite, via spread spectrum techniques, or via optical communication links.

In keeping with an aspect of the invention, environmental monitor 10 may be provided power management circuitry 115 to facilitate efficient energy consumption. Power management circuitry 115 preferably includes a power source 120 and a power manager 125 for controlling power output from power source 115. Power manager 125 communicates with display 57 and controls powerup and shutdown of monitor 57. For example, in accordance with the user's wishes, display 57 may be driven into low power consumption mode after a period of inactivity or it may be shut down all together. In addition, display 57 may be automatically powered up upon deployment of one or more of sensors 33-37 or upon some other event.

Turning to a particularly preferred aspect of the invention, central processing unit 110 is preferably programmed to carry out a physiological heat strain model to determine at least the following safety factors for workers and others exposed to extreme heat: 1) optimal work/rest cycle limits, 2) hourly water consumption needs and 3) maximum safe work time. In addition, CPU 110 may compute the following environmental parameters WBGT (computed from, mean radiant temperature, dew point and air-cooling power). A preferred physiological heat strain model uses both measured parameters and user input parameters to calculate the above safety factors. More particularly, the preferred heat strain model employs the following measured inputs: air temperature, humidity, solar radiation, wind speed and barometric pressure. In addition, the preferred heat strain model uses the following user supplied inputs: clothing type, work rate and acclimation status. A particularly preferred heat strain model is that described in Computer Biological Medicine, by Pandolf et al., Vol. 16 No. 5, pp. 319-329, 1986, which is herein incorporated by reference.

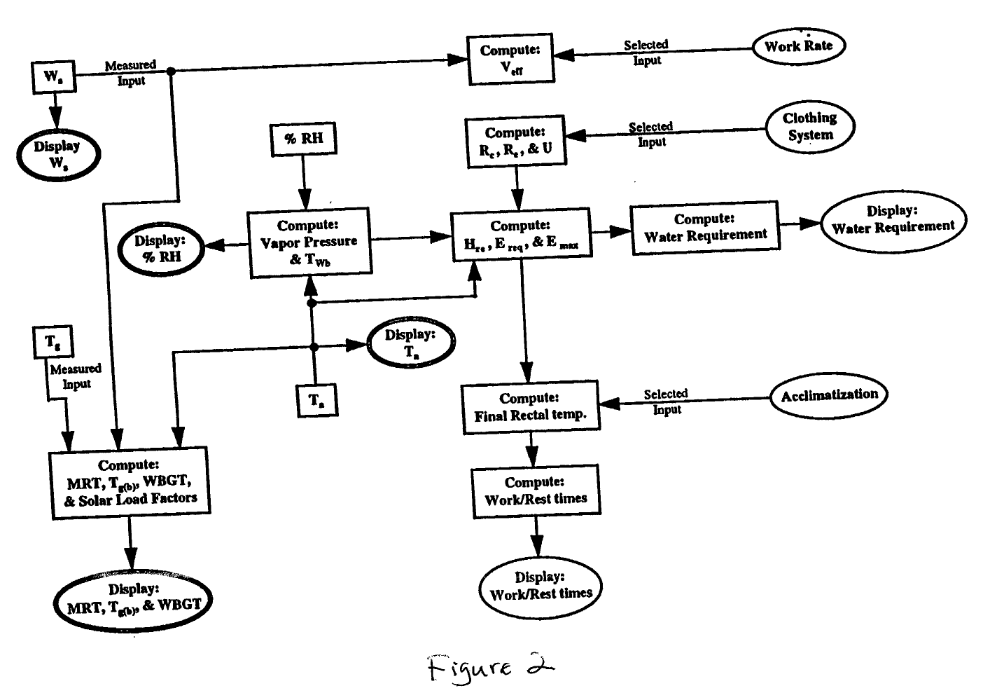

The heat strain model may be realized as software to provide real-time safety factors and environmental parameters upon demand for assessing the effects of heat stress on human beings. A diagram representing the steps to be performed by the software in the preferred embodiment is shown in FIG. 2. The software may be implemented as a computer program or other electronic device control program or an operating system. The software may be resident in the environmental monitor 10 in CPU 110, if desired. Alternatively, CPU 110 including the software may be resident in a stand-alone device in communication with environmental monitor 10 either continuously or intermittently. The standalone device may be a standard personal computer (PC), a PAL device, a personal digital assistant (PDA), an e-book or other handheld or wearable computing devices (incorporating Palm OS, Windows CE, EPOC, or future generations like code-named Razor from 3Com or Bluetooth from consortium including IBM and Intel), or a specific purpose device receiving signals from environmental monitor 10. Depending on the location of the software, the software may be stored, for example, in random access memory (RAM); in read only memory (ROM); on a storage device like a hard drive, disk, compact disc, punch card, tape or in other computer readable material; in virtual memory on a network such as an intranet or the Internet, computer or otherwise; on an optical storage device; on a magnetic storage device; and/or on an EPROM. The software may be modified or updated as desired.

In operation, the user preferably deploys sensors 33-37 and activates monitor 10. Monitor 10 may be activated automatically when sensors are deployed or may be manually activated by the user. Upon activation, display 57 preferably shows various parameters and indicia including date, time and power status. The user may then activate a selection menu on LCD 57 and select the appropriate input parameters, i.e., the type of clothing, the work rate and the acclimation status. The input parameters are then transferred to CPU 110. The selection menu preferably provides the user with a variety of options for each parameter from which the user may select. Further, upon activation of the monitor 10, sensors 33-37 collect data and transmit the collected to CPU 110. The user may then request computation of any one or more of the safety factors and environmental parameters described above. In accordance with a preferred aspect of the invention, over a two-minute span, sensor measurements may be made at one-second intervals, averaged and input to CPU 110. The safety factors may be calculated and output by CPU 110 either to display 57 or to a remote server in as little as three seconds. A preferred algorithm for calculation of safety factors and environmental parameters is depicted in FIG. 2. Accordingly, environmental monitor 10 provides real time computation of safety factors.

In accordance with another feature of the invention, the environmental monitor 10 may be operated in automatic mode. That is, environmental monitor 10 may be set to log data from sensors 33-37. The user may input start time, duration and interval for sensors to take readings. All data logged is saved and, when logging is complete, data may be viewed on display 57 and/or downloaded to a server for viewing and computation of safety factors via communication port 135.

Upon calculation of the safety factors, the safety factors may be displayed in graphical or alphanumerical fashion. For example, a cyclic work guidance display screen may show optimal minutes of work/rest per hour to keep predicted body core temperature within safe limits as well as amount of water to drink per hour to replace predicted sweat losses. A continuous work guidance display screen may show predicted maximum safe work time in minutes for a one-time bout of continuous work and the amount of drinking water needed to replace predicted sweat loss. An environmental data screen may show measured environmental parameters such as air temperature, relative humidity, wind speed, black globe temperature and barometric pressure. In addition, the environmental data screen may show calculated environmental parameters such as wet bulb temperature, mean radiant temperature, and the wet bulb-globe temperature (WBGT) index.

The above-described display screens may be provided on display 57, However, CPU 110 may also transmit the display information directly to a server simultaneously, serially or to the exclusion of display 57 for display on a server monitor. Of course, in embodiments of environmental monitor 10 that do not include display 57, CPU 110 transmits the display information directly to the server and information is displayed on the server monitor.

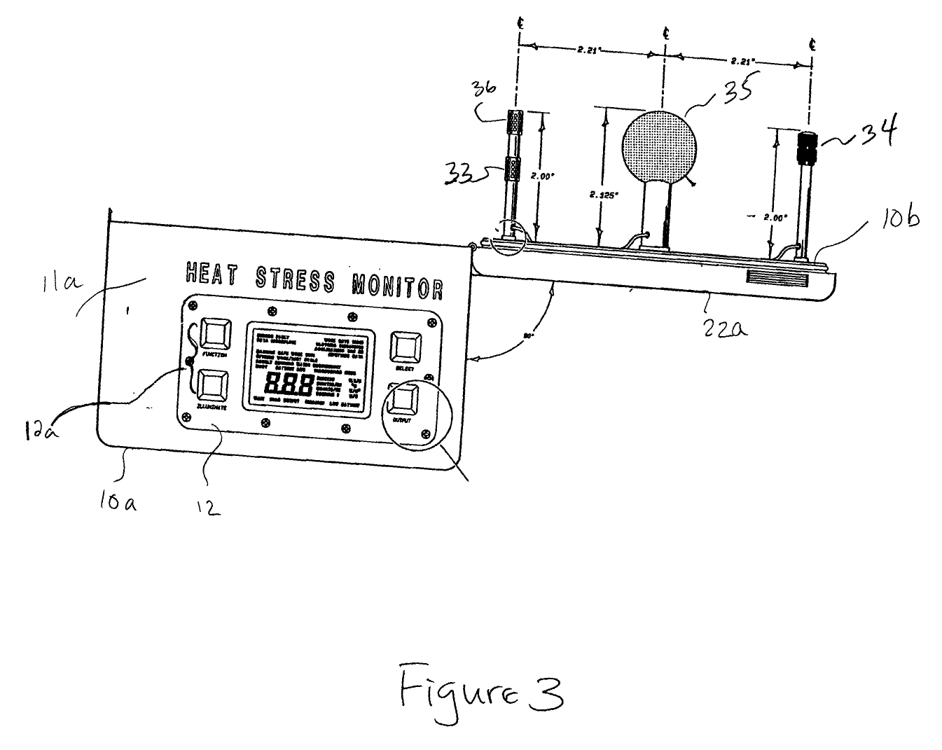

FIG. 3 illustrates a specific embodiment of the environmental monitor 10 in accordance with the invention. Environmental monitor 10 is adapted for use in monitoring environmental conditions associated with heat stress, and has sensors and programming appropriate for that application. However, monitor 10 could be easily adapted for monitoring other environmental conditions, such as cold, air quality, and noise. Appropriate sensors could be added or substituted for those described herein.

Structurally, environmental monitor 10 is comprised of a case including a main body 10a and a sensor module 10b. In FIG. 3, sensor module 10b is shown in the “deployed” position, positioned for operation of its sensors. A hinged cover 22a of main body 10a is open to facilitate deployment of the sensors.

The main body 10a of monitor 10 has a front face 11a, and a keypad 12 with individual keys 12a. A CPU 110 for computation of safety factors and environmental stress parameters such as that described above may be disposed within main body 10a.

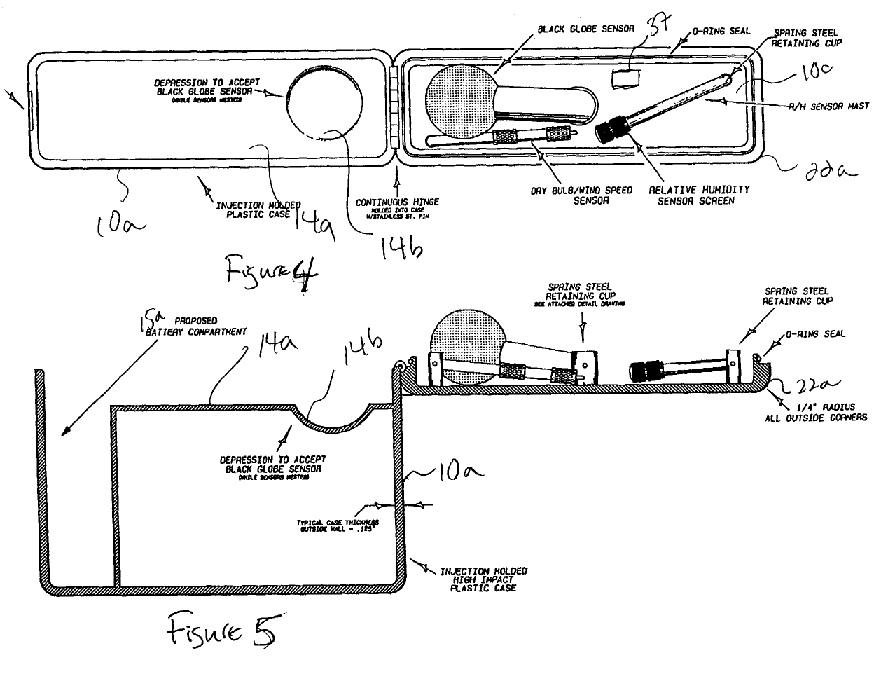

As illustrated in FIGS. 4 and 5, main body 10a includes a shelf 14d including a substantially spherical depression 14e dimensioned to accept the black globe sensor described in greater detail below when the sensors are in the rest or nestled position. More particularly, spherical depression 14e may have a diameter equal to or less than about 1.125″. Main body 10a may also be provided with a compartment 15a for storing a power source, e.g., a battery (not shown).

Sensor module 10b is preferably releasably disposed in hinged cover 22a. Sensor module 10b may be snap fit, friction fit or otherwise matingly engaged with hinged cover 22a. A feature of the invention is that monitor 10 easily permits sensor modules 10b to be interchanged and used with the main body 10a. All signal processing and calibration information is stored in the sensor module 10b, with a digital control interface to the main body 10a.

Sensor module 10b is comprised of a substantially planar base 10c which supports a dry bulb sensor 33, relative humidity sensor 34, black globe sensor 35, and wind speed sensor 36. Sensors 33-36 are illustrated in FIG. 3 in their deployed position. That is, sensors 33-36 are position erect, substantially perpendicular to planar base 10c. Sensors 33-36 may be placed in their storage position by folding down each sensor as described in detail below and closing hinged cover 22a. In the storage position, sensors 33, 34 and 36 will be substantially flush with planar base 10c and the globe of sensor 35 will be nestled in depression 14e. Accordingly, cover 22a may be closed and mated with main body 10a. FIGS. 4 and 5 illustrate sensors 33-36 in their storage position, substantially parallel to planar base 10c prior to closing cover 22a.

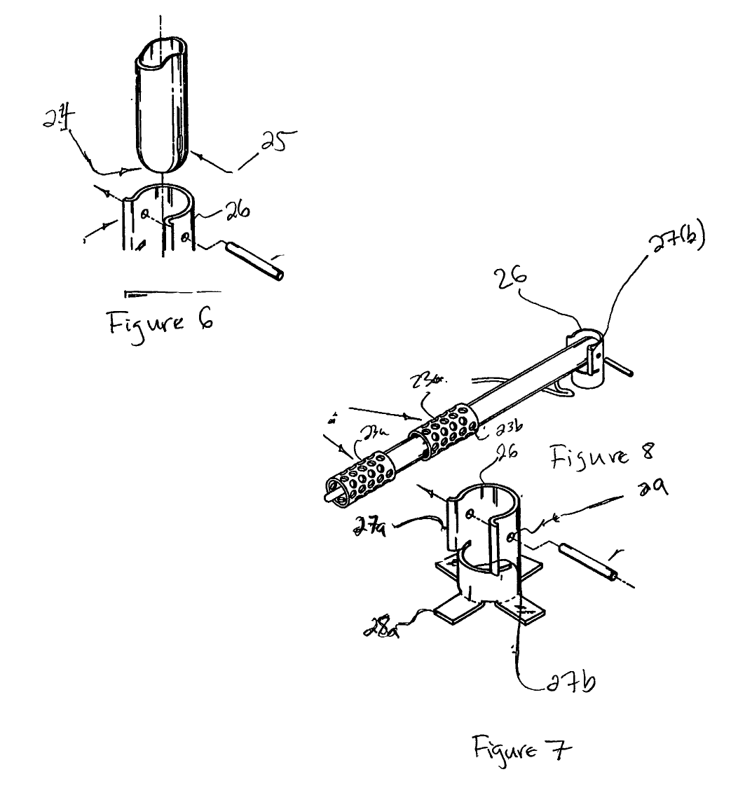

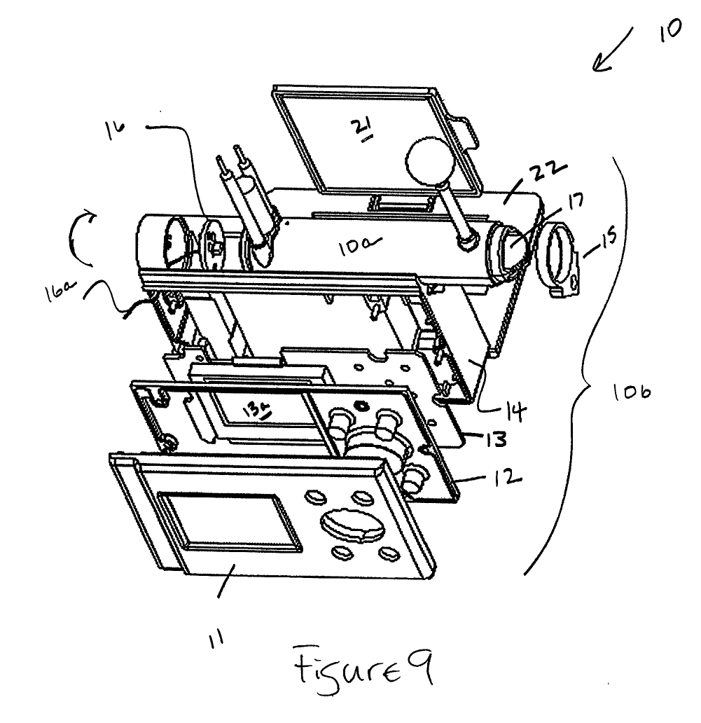

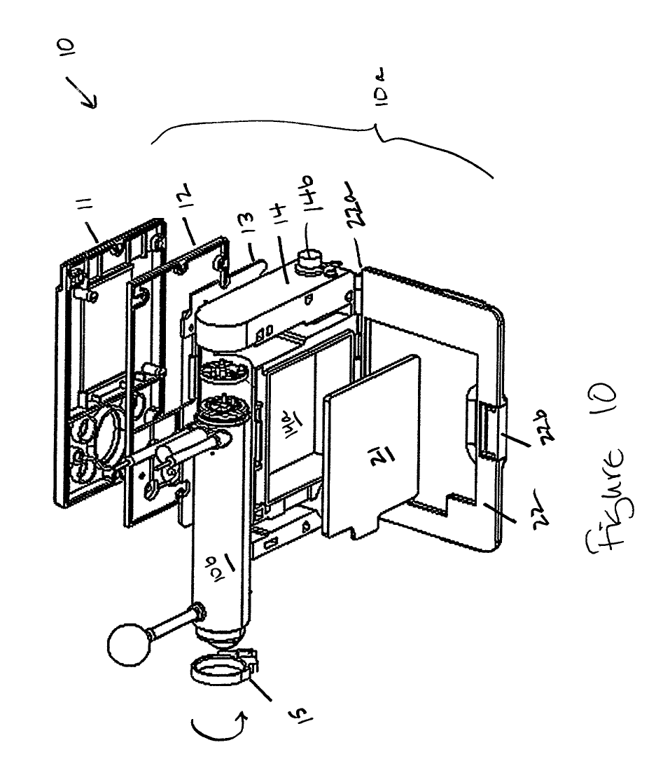

Each of sensors 33-36 is attached to or coupled with a mast 23 and the mast is secured to planar base 10c. Mast 23 is preferably comprised of a thin walled stainless steel tube member as depicted in FIGS. 6-8. As best shown in FIG. 6, each mast has a substantially hemispherical closed end 24 and a clearance slot 25 disposed along a side of mast 23 proximate to closed end 24. Closed end 24 is configured for hinged engagement with spring retainer cup 26 to permit rotation of sensors 33-36 through an angle of approximately 90° from rest position to deployed position. Spring retainer cup 26, depicted in greater detail in FIG. 7, defines a collar having first and second wings 27a and 27b. Spring retainer 26 is preferably formed form stainless steel or beryllium copper. Lodging mast 23 into spring retainer 26 and threading roll pin 28 through eyelets 29 and clearance slot 25 may establish a secure hinged connection. Wings 27a and 27b are inwardly biased to secure mast 23 in position as shown in FIG. 8. Spring retainer 26 is further provided with extension ears 28a that may be potted into planar base 10c.

Although a preferred coupling system for sensors 33-36 is described above, the invention is not limited to such a system. Sensors 33-36 may be coupled to planar base 10c using any mechanism that allows sensors 33-36 to be moved to and from and locked into their deployed and storage positions.

As discussed above, each of sensors 33-36 are disposed on a mast 23 as shown. Dry bulb sensor 33 and wind speed sensor 36 are preferably disposed on the same mast 23. FIG. 8. However, wind speed sensor 36 is preferably disposed above dry bulb sensor 33 near the top end of mast 23. To prevent damage to wind speed sensor 36 and dry bulb sensor 33, a protective covering 23a may be disposed about the respective sensors. An exemplary protective covering is illustrated in FIG. 8 is a stainless steel collar having a plurality of perforations 23b to facilitate airflow. Wind speed sensor 36 and dry bulb sensor 33 may be of a type known to those of skill in the art. For example, both wind speed sensor 36 and dry bulb sensor 33 may be realized by thermistors.

Likewise, black globe sensor 35 and relative humidity sensor 34 are of the type generally known to those of skill in the art. In accordance with a feature of the invention, the wet bulb globe temperature (WBGT) may be obtained by measuring relative humidity with sensor 34 and the dry bulb temperature with sensor 33 and using a mathematical formula to determine wet bulb temperature. Alternatively, a dedicated wet bulb sensor could be used in sensor module 10b.

An atmospheric pressure sensor 37 is preferably located inside sensor module 10b. In the embodiment of FIG. 4, pressure sensor 37 may be mounted on planar base 10c. In addition, sensor electronics 60 may be disposed on the underside of planar base 10c. In preferred embodiments, sensor electronics 60 may be implemented on a printed circuit board (not shown), which may be readily attached to planar base 10c.

In keeping with the invention, the user may control operation of environmental sensor 10 using keypad 12a. Specifically, using keypad 12a, the user may perform one or more of the following: a) input environmental stress parameters, b) control illumination of display 57 and c) direct CPU 110 to compute environmental stress parameters and environmental safety factors.

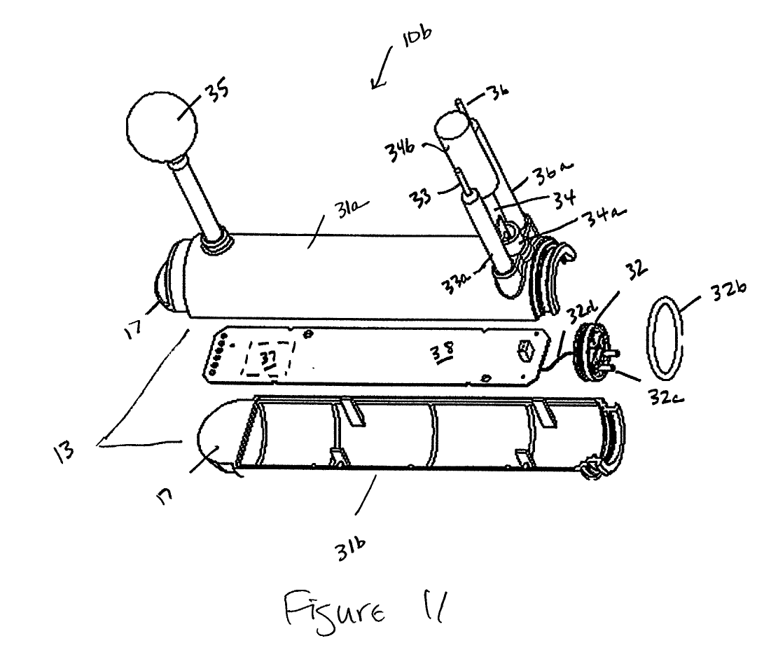

FIGS. 9-15 illustrate still another embodiment of the invention. FIGS. 9 and 10 are exploded front and rear views of an environmental data monitor 10 in accordance with the invention, respectively. In the example of this description, monitor 10 is adapted for use in monitoring environmental conditions associated with heat stress, and has sensors and programming appropriate for that application. However, monitor 10 could be easily adapted for monitoring other environmental conditions, such as cold, air quality, and noise. Appropriate sensors could be added or substituted for those described herein.

Structurally, monitor 10 is comprised of a main body 10a and a sensor module 10b. In FIGS. 9 and 10, sensor module 10b is in the “deployed” position, positioned for operation of its sensors. A hinged rear cover 22 of main body 10a is open, but could be closed to protect the sensors of sensor module 10b during use.

The main body 10a of monitor 10 has a front piece 11, a keypad 12, a CPU board 13, with a midpiece 14, a battery cover 21, a rear cover 22 with latch 22a, an endpiece 15, and a sensor module connector 16.

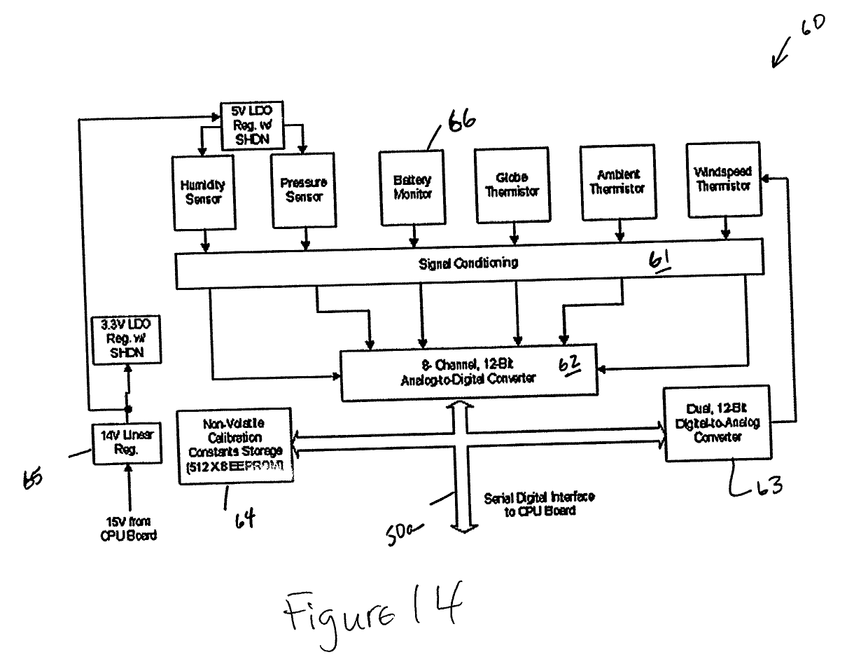

CPU board 13 is located between front piece 11 and midpiece 14. On its front side, CPU board 13 contains the graphics display and traces for keypad 12. Other electronic components are on the rear side. The electrical circuitry of CPU board 13 is explained below in connection with FIG. 13.

Midpiece 14 has a curved sensor bed 14c at its top end. As explained below, sensor bed 14c, such that sensor module 10b may rotate at least 180 degrees. FIG. 10 illustrates this rotation.

Sensor module connector 16 attaches to midpiece 14, such as by screws. The attachment is after its wiring harness 16a is threaded to CPU board 13. Sensor module connector 16 has alignment holes 16b, which prevent a rotating connector 32 on sensor module 10b from making contact with sensor module connector 16 until it is properly aligned.

A battery compartment 14a in midpiece 14 contains four AA-size batteries wired in series to provide a nominal six-volt DC power source. A battery cover 21 is a friction fit rubber cover, which seals the battery compartment 14a when rear cover 22 is closed.

The ‘+’ and ‘−’ terminals of the batteries protrude through the battery compartment 14a and a wiring harness connects them to CPU board 13. An external connector 14b also attaches to CPU board 13 with a wiring harness. All wiring harnesses are of sufficient length to allow CPU board 13 to be removed from the midpiece 14 and manipulated for repair.

Once all wiring harnesses are attached to the CPU board 13, keypad 12 is placed into the front piece 11. Keypad 12 is made from conductive rubber and forms a weatherproof seal where it comes in contact with the midpiece 14. The front piece 11 attaches to the midpiece 14 by screws that enter through the rear of the midpiece 14.

Rear cover 22 and midpiece 14 have a hinge-type attachment 22a along their bottom edges. A sliding latch 22b is attached to the rear cover 22 by compression springs, which hold latch 22b in its latched position. Operating the latch 22b opens the rear cover 22. A compressible gasket may be attached to the perimeter of the rear cover 22 to serve as a seal and to allow the rear cover 22 to spring out from the midpiece 14 when unlatched.

Sensor module 10b is cylindrical in shape, with a rotating connector 32 at one end and a rotation knob 17 at the other. Connector 32 permits sensor module 10b to rotate within the sensor bed 14c of midpiece 14.

When monitor 10 is in the “storage” position (not shown), sensor module 10b is rotated approximately 180 degrees from the “deployed” position illustrated in FIGS. 9 and 10. This permits its sensors to be placed under rear cover 22, when cover 22 is hinged shut.

For assembly, sensor module 10b is slid into position on the main body 10a with the sensors in their deployed position and the rear cover 22 unlatched. Once the sensor module 10b is seated properly, endpiece 15 is positioned over the knob 17 and attached to the midpiece 14 with screws. For the storage position of monitor 10, the sensors can be rotated into the sensor cavities in the midpiece 14, and the rear cover 22 can be closed.

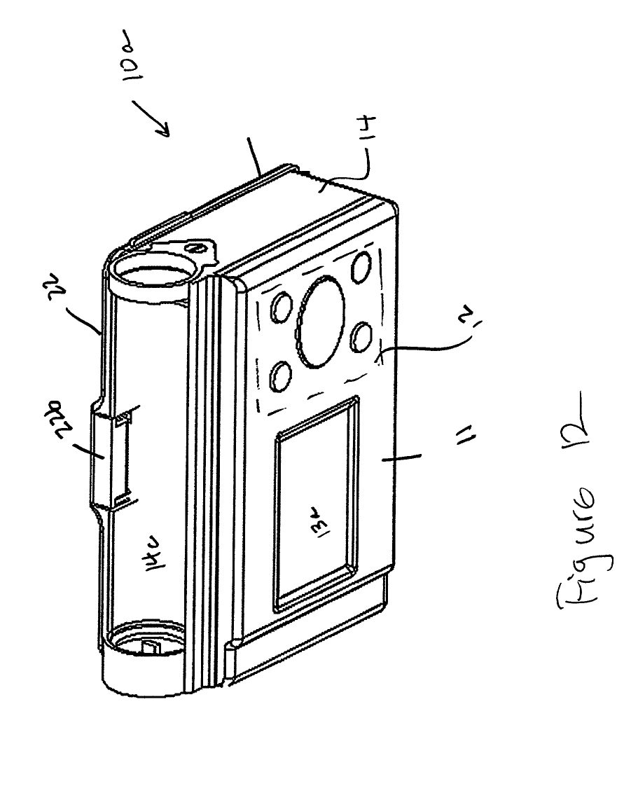

FIG. 11 illustrates sensor module 10b in further detail. A feature of the invention is that monitor 10 easily permits sensor modules 10b to be interchanged and used with the main body 10a. All signal processing and calibration information is stored in the sensor module 10b, with a digital control interface to the main body 10a.

Sensor module 10b is comprised of a cylindrical housing 31, having an upper half 31a and a lower half 31b. The two parts of housing 31 are screwed together, ultrasonically welded, glued, or otherwise attached.

The upper half 31a provides a platform for various sensors. In the embodiment of FIG. 11, sensor module 10b has a dry bulb sensor 33, relative humidity sensor 34, black globe sensor 35, and wind speed sensor 36. Thus, monitor 10 has three thermistors: dry bulb, black globe, and wind speed. Wet bulb globe temperature (WBGT) is obtained by measuring relative humidity with sensor 34 and the dry bulb temperature with sensor 33 and using a mathematical formula to determine wet bulb temperature. Alternatively, a dedicated wet bulb sensor could be used.

The dry bulb sensor 33, globe sensor 35, and wind speed sensor 36 are each located on a mast 33a, 35a, and 36a. These masts protrude perpendicular to the face of the cylindrical housing 31. A removable light-shadowing housing 34b covers the humidity sensor 34.

Sensor PCB (printed circuit board) 38 is contained within sensor housing 31, between upper half 31a and the lower half 31b. Sensor PCB 38 contains the sensor electronics 50, described below in connection with FIG. 14.

An atmospheric pressure sensor 37 is located inside sensor module 10b. In the embodiment of FIG. 11 pressure sensor 37 is mounted on the underside of sensor PCB 38.

At one end of sensor module 10b is a rotating connector 32, which has a groove on its edge to allow it to rotate within cylindrical housing 31. The upper half 31a and lower half 31b of housing 31 have mating ridges. An O-ring 32b is slipped onto the cylindrical housing 31.

When rotating connector 32 is plugged into fixed connector 16, there is a seated rotating connection between sensor module 10b and main body 10a. As a result of the rotating connector 32 and O-ring 32b, sensor module 10b is sealed from the effects of the environment. Alignment pins 32c provide strain relief for the connector pins and sockets when sensor module 10b is rotated.

Referring again to FIGS. 9 and 10, main body 10a has cavities into which the various sensors fit when sensor module 10b is rotated approximately 180 degrees into a “storage” position. The arrow is FIG. 10 illustrates the direction of rotation. The hinged rear cover 22 is closed to protect the sensors when they are stored. Cover 22 can also be re-closed after it is opened and the sensors are deployed into their “operate” position.

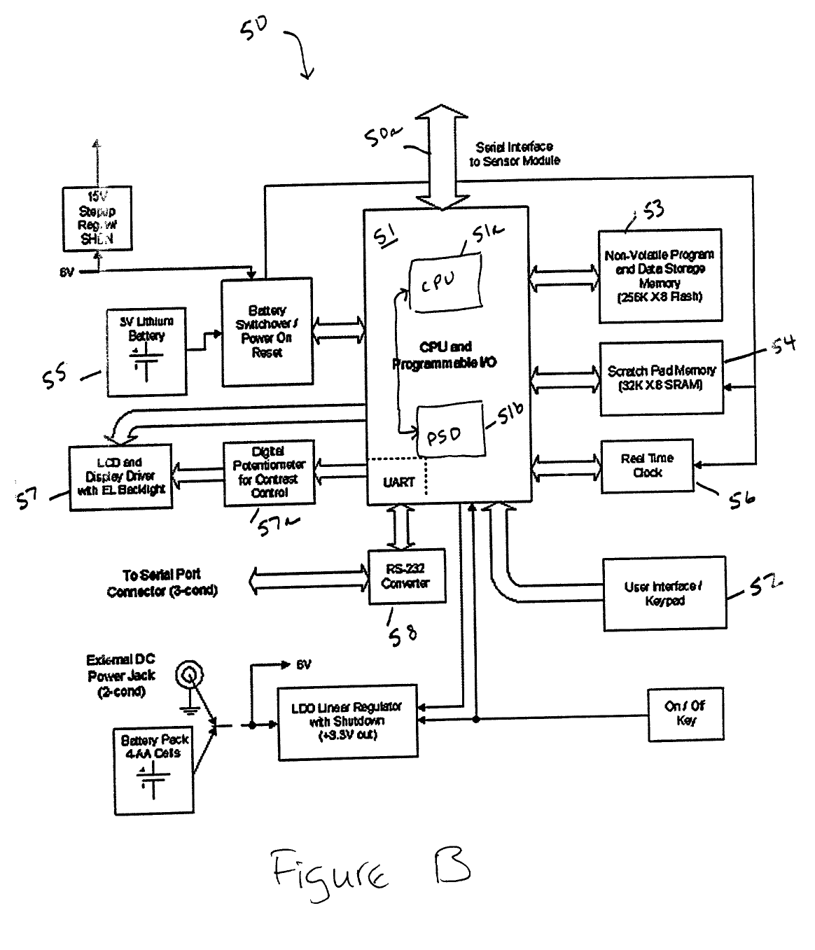

As stated above in connection with FIGS. 9 and 10 and as also illustrated in FIG. 12, main body 10a has an endpiece 15. The endpiece 15 fits over a rotation knob 17 on sensor module 10b. It attaches to main body 10a and holds sensor module 10b in place. Endpiece 15 may be removed to permit sensor module 10b to be removed, such as for replacement or repair.

Discrete wires 32d from the rotating connector 32 are attached to the sensor PCB 38. When the assembled sensor module 10b is attached to the main body 10a, rotating connector 32 is held in a fixed position with respect to the main body 10a by a mated connection. When the knob 17 is used to rotate the sensor module 10b, the upper half 31a, lower half 31b, and sensor PCB 38 rotates around the rotating connector 32.

FIGS. 13 and 14 are functional block diagrams of the electronics of the present invention. FIG. 13 illustrates the main electronics 50 contained within main body 10a. FIG. 14 illustrates the sensor electronics 60 contained within sensor module 10b. A serial digital interface 50a provides the electrical connection between main electronics 50 and sensor electronics 60.

Main electronics 50 has a central processing unit (CPU) 51a with a peripheral system device (PSD) 51b. The PSD 51b provides address decode logic, additional static RAM and digital I/O ports, and a bootloader routine for the flash memory 53. A static RAM 54 provides both scratchpad memory and nonvolatile storage for data logging applications. RAM 54 is backed up by a lithium battery 55. The lithium battery 55 also maintains a real time clock 56, which can be used for timestamping logged data. The graphics display 57 is addressed by the CPU 51a and uses a digital potentiometer 57a for contrast adjustment. The backlight control for the graphics display 57 is controlled by the PSD 51b. The keypad 52 is interfaced to digital I/O ports on the PSD 51b.

The system is powered by a DC power source, which may be either user-replaceable batteries placed in compartment 14a or an external power source.

An RS-232 converter 58 converts the TTL-level signals on the CPU board 10 to RS-232 signals for the external serial connector. The main body 10a of monitor 10 functions as an intelligent user interface containing the graphics display, keypad, power supply CPU and associated digital electronics. The main body also contains an external port that can be used to supply external power and communicate with a personal computer through an RS-232 interface. Software can also be loaded into the device through this port and stored in flash memory.

The connection between main body 10a and sensor module 10b provides battery power, supply voltage, and a digital control interface. All sensing electronics and storage for calibration and sensor identification information is located on the sensor module 10b. This allows sensor module 10b to be calibrated independently of the main body 10a and to produce the same results when attached to any main body 10a.

The design of monitor 10 permits different types of sensor modules to be used with the main body, whereby the sensor module 10b can be queried by the main body 10a to determine the type of each sensor and its calibration information. The application software in the main body 10a can then configure itself to acquire and display the sensor data. Alternatively, a dedicated application for a given type of sensor module 10b can be loaded into the flash memory 53 through an external port.

Referring to FIG. 14, the sensor electronics 60 contains signal conditioning circuitry for the dry bulb sensor 33, the black globe sensor 35, the relative humidity sensor 34, the wind speed sensor 36, and the pressure sensor 37.

The analog voltages produced by the various sensors are digitized by the A/D converter 62. A D/A converter 63 is used to provide current to the wind speed sensor 36 and to heat it to a constant temperature above the dry bulb temperature. The amount of power required to heat the wind speed sensor 36 is related to the wind speed.

An EEPROM 64 stores all calibration information related to the sensors 33-37. The calibration information may include various calibration constants, unique to each sensor. In general, all circuitry and programming unique to any sensor is placed on sensor module 10b rather than in main body 10a so that sensor modules having the same, or different, sensors may be easily interchanged.

A/D converter 62, D/A converter 63, and EEPROM 64 all share the same serial control lines on the interface 50a, with the exception of their chip select signals. This minimizes the number of connections that need to be made between the CPU electronics 50 and the sensor electronics 60.

Voltage regulator 65 produces a stepped-up voltage for the sensor electronics 60. The battery voltage is delivered to the sensor electronics 60, where it is input to a battery monitor 66, whose output signal is converted to digital form by A/D converter 62, and delivered back to the CPU electronics 60. The location of battery monitor 66 in sensor electronics 60 is merely for convenience of using A/D converter 62, and in other embodiments, battery monitor 66 could be part of CPU electronics 50.

CPU 51a can be programmed to execute various environmental data processing algorithms. For example, when monitor 10 is used to heat stress monitoring, known heat strain models can be used. For example, a model based on the WBGT index may be used.

A feature of the invention is the incorporation of wind speed into heat strain models. As a result, the effect of evaporative cooling is considered in determining weather effects.

Measured parameter data acquired from sensor module 10b can be combined with user input parameter data acquired via keypad 12 or other means. Such parameters might include, clothing type, work type, or work rate.

As stated above, monitor 10 can be easily adapted for use with other or additional sensors. For example, one sensor might be an air quality sensor, such as one that measures oxygen content or one or more pollutants. Or, a sensor might measure noise. Other sensors might measure the user's physiological conditions, such as heart rate, blood pressure, or body temperature (skin or core). For physiological monitoring, sensors such as used by athletes could be used—for example, a heart rate monitor that attaches to the user's finger and provides input to the A/D converter 62 of sensor module 10b or directly to the processor 51 of the main body 10a.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable environmental heat stress monitor, comprising:
a main housing having a front piece and a rear cover;
a sensor module operable to move from a sensor deployed position to a sensor storage position;
a plurality of sensors attached to the sensor module, each sensor mounted on a mast, such that the sensors extend outwardly from the main housing when the sensor module is in the deployed position and rest in the main housing when the sensor module is in the storage position, the sensors including at least a humidity sensor and a wind speed sensor;
a main electronics circuit contained within the main housing, operable to process data acquired by the sensors and to provide heat stress data output that incorporates wind speed as a parameter;
a sensor electronics circuit contained within the sensor module;
a display viewable at the outer surface of the main housing for providing read out information; and
a keypad for receiving input from a user.

2. A portable environmental heat stress monitor comprising:
a main housing;
a cover hingedly connected to said main housing;
a sensor module disposed in said cover, said sensor module including a planar base;
a plurality of sensors, each sensor mounted on a mast, the mast being pivotally attached to the planar base such that each sensor extends substantially orthogonally from the planar base in deployed position and such that each sensor is disposed substantially parallel to the planar base in a storage position, the sensors including at least a humidity sensor and a wind speed sensor;
a central processing unit in communication with said plurality of sensors to receive input signals from at least one of said plurality of sensors; and
an input device that transmits environmental stress parameter inputs to said central processing unit whereby said central processing unit computes work/rest cycles responsive to the sensor input signals and the environmental stress parameters.

3. The monitor of claim 2, wherein the sensors include an ambient temperature sensor and a humidity sensor.

4. The monitor of claim 2, wherein the sensors include a black globe sensor.

5. The monitor of claim 2, wherein the sensors include a wind speed sensor.

6. The monitor of claim 2, further comprising an atmospheric pressure sensor within the sensor module.
